(19) United States
(12) Patent Application Publication
(10) Pub. No.: US 2016/0192426 A1
(43) Pub. Date: Jun. 30, 2016

(54) DEVICE-TO-DEVICE DISCOVERY METHOD IN WIRELESS COMMUNICATION SYSTEM

(71) Applicant: ELECTRONICS AND TELECOMMUNICATIONS RESEARCH INSTITUTE, Daejeon (KR)

(72) Inventors: Taegyun NOH, Daejeon (KR); Kyoung Seok LEE, Daejeon (KR); Choongil YEH, Daejeon (KR); Jae Young AHN, Daejeon (KR)

(73) Assignee: Electronics and Telecommunications Research Institute, Daejeon (KR)

(21) Appl. No.: 14/910,804

(22) PCT Filed: Aug. 6, 2014
(86) PCT No.: PCT/KR2014/007276

§ 371 Date: Feb. 8, 2016

(30) Foreign Application Priority Data
Aug. 8, 2013 (KR) 10-2013-0094436
Sep. 27, 2013 (KR) 10-2013-0115657
Nov. 1, 2013 (KR) 10-2013-0132544
Jan. 28, 2014 (KR) 10-2014-0010473
Jul. 30, 2014 (KR) 10-2014-0097451

(51) Int. Cl. H04W 76/02; H04W 74/08; H04W 76/04; H04W 72/04; H04W 8/00

(52) U.S. Cl. CPC H04W 76/023; H04W 72/0413; H04W 72/0446; H04W 8/005; H04W 76/046; H04W 74/0833

(57) ABSTRACT

Disclosed herein is a device-to-device discovery method in a wireless communication system. A device determines whether a first subframe for a physical layer uplink channel or signal and a second subframe for the discovery signal are the same. The device transmits the physical layer uplink channel or signal without transmitting or receiving the discovery signal, in the same subframe, when the first subframe and the second subframe are the same.

### TECHNICAL FIELD

The present invention relates to a device-to-device discovery method in a wireless communication system.

### BACKGROUND ART

Recently, to provide application services based on proximity, device-to-device communication has increasingly gained interest, and various technologies for supporting the device-to-device communication have been suggested. Even in 3GPP LTE, various methods for device-to-device communication have been suggested.

For the device-to-device communication, a device requires a procedure for discovering a counterpart device, and the device transmits a discovery signal to discover the counterpart device. Meanwhile, a need exists for a method for efficiently transmitting the discovery signal.

### DISCLOSURE

### Technical Problem

The present invention has been made in an effort to provide an efficient device-to-device discovery method.

### Technical Solution

An exemplary embodiment of the present invention provides a method for transmitting or receiving a discovery signal by a device. The method may include: determining whether a first subframe for a physical layer uplink channel or signal and a second subframe for the discovery signal are the same; and if it is determined that the first subframe and the second subframe are the same, in the same subframe, transmitting the physical layer uplink channel or signal without transmitting or receiving the discovery signal.

The first subframe for the physical layer uplink data channel or signal may be subframe transmitting a physical layer uplink control channel.

The first subframe may be a subframe cell-specifically configured to transmit a sounding reference signal.

The first subframe may be subframe in which a resource region of a physical random access channel is included.

The device may is a device transmitting the physical random access channel.

Another embodiment of the present invention provides a method for transmitting or receiving a discovery signal by a device. The method may include: determining whether a physical random access channel is transmitted in a subframe in which a resource region of the physical random access channel is included; and if it is determined that the physical random access channel is not transmitted in the subframe, transmitting or receiving the discovery signal in the rest of the resource excluding the resource region of the physical random access channel and the physical layer uplink control channel from the subframe.

The subframe may be a subframe being excluded from a subframe cell-specifically configured to transmit a sounding reference signal, a subframe transmitting a physical layer uplink data channel, or a subframe transmitting a physical layer uplink control channel.

Yet another embodiment of the present invention provides a method for transmitting or receiving a discovery signal by a device. The method may include: transmitting or receiving the discovery signal using at least one resource from which a resource region of a physical random access channel is excluded, without transmitting or receiving the discovery signal in the resource region of the physical random access channel.

Still another embodiment of the present invention provides a method for transmitting or receiving a discovery signal by a device. The method may include: excluding a subframe in which a physical layer uplink channel or signal is included, in a resource region transmitting or receiving the discovery signal; and transmitting or receiving the discovery signal by selecting at least one resource in the excluded resource region.

The subframe may be at least one of a subframe configured to transmit a physical random access channel, a subframe cell-specifically or UE-specifically configured to transmit a scheduling request, a subframe cell-specifically or UE-specifically configured to transmit a sounding reference signal, a subframe transmitting the physical layer uplink control channel including uplink Ack/Nack, a subframe transmitting the physical layer uplink control channel including periodic channel state information, and a subframe transmitting the physical layer uplink data channel.

The uplink Ack/Nack may be for a physical layer downlink data channel corresponding to initial transmission of downlink semi-persistent scheduling (SPS), and the subframe transmitting the physical layer uplink data channel may transmit a physical layer uplink data channel corresponding to initial transmission or retransmission of uplink semi-persistent scheduling.

Still another embodiment of the present invention provides a method for allowing a plurality of devices to transmit a discovery signal to a counterpart device. The method may include: dividing the plurality of devices into a group including a first device group and a second device group; dividing a resource region used to transmit the discovery signal into a group including a first resource group and a second resource group; transmitting, by the first device group, the discovery signal using the first resource group, in a first period; transmitting, by the second device group, the discovery signal using the second resource group, in the first period; transmitting, by the second device group, the discovery signal using the first resource group, in a second period; and transmitting, by the first device group, the discovery signal using the second resource group, in the second period.

The first resource group may have a smaller amount of resources than the second resource group.

The dividing of the plurality of devices may include dividing the plurality of devices into a group including the first device group, the second device group, and a third device group, and the method may further include: transmitting, by the third device group, the discovery signal using the second resource group, in the first period and the second period; transmitting, by the third device group, the discovery signal using the first resource group, in a third period; and transmitting, by the first device group and the second device group, the discovery signal using the second resource group, in the third period.

The dividing of the plurality of devices may include: informing, by a base station, the plurality of devices of the number of groups; and selecting, by each of the plurality of devices, their own groups using a hash function.

The first resource group and the second resource group may be identified in a time domain.

The time domain may be represented by variables including an offset, a first cycle, a second cycle including multiple of the first cycle, and a bitmap.

The first resource group and the second resource group may be identified by a frequency domain, and each resource group may be configured of physical resource block pairs.

The first period and the second period may correspond to the first cycle.

The first resource group and the second resource group may be a resource from which a physical random access channel is excluded.

### Advantageous Effects

According to an exemplary embodiment of the present invention, it is possible to perform the efficient device-to-device discovery in the wireless communication system.

### DESCRIPTION OF THE DRAWINGS

FIG. 1 is a diagram illustrating various environments in which device-to-device discovery according to an exemplary embodiment of the present invention may be generated.

FIG. 2 is a diagram illustrating a connection relationship of the device-to-device discovery according to the exemplary embodiment of the present invention.

FIG. 3 is a diagram illustrating a procedure of a first discovery method according to an exemplary embodiment of the present invention.

FIG. 4 is a diagram illustrating a procedure of a second discovery method according to an exemplary embodiment of the present invention.

FIG. 5 is a diagram illustrating a discovery resource region in a time domain according to an exemplary embodiment of the present invention.

FIG. 6 is a diagram illustrating a method for allocating a discovery resource region according to the exemplary embodiment of the present invention to a plurality of groups.

FIG. 7 is a diagram illustrating resource group A—resource group B according to an exemplary embodiment of the present invention.

FIG. 8 is a diagram illustrating a comparing simulation between a basic scheme and the scheme according to the exemplary embodiment of the present invention.

FIG. 9 is a diagram illustrating multiplexing of the discovery resource region and a physical layer uplink channel according to the exemplary embodiment of the present invention.

FIG. 10 is a diagram illustrating a case in which a resource region for a physical random access channel and a resource to transmit or receive a discovery signal overlap each other in the resource region illustrated in FIG. 9.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a device may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), a machine-type communication device (MTCD), and the like, and may also include functions of all or some of the device, the MT, the AMS, the HR-MS, the SS, the PSS, the AT, the UE, the MTCD, and the like.

Further, a base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like, and may also include functions of all or some of the ABS, the HR-BS, the nodeB, the eNodeB, the AP, the RAS, the BTS, the MMR-BS, the RS, the HR-RS, and the like.

Meanwhile, throughout the specification, the base station is used as a control device which controls a single cell. A physical base station in an actual communication system may control a plurality of cells. In this case, the physical base station, that is, the base station described in the specification, may be provided in plural. That is, allocating different parameters to each cell may mean allocating different values to each base station.

In the wireless communication system, a signal may be directly transmitted and received between devices, and a device may discover a counterpart device.

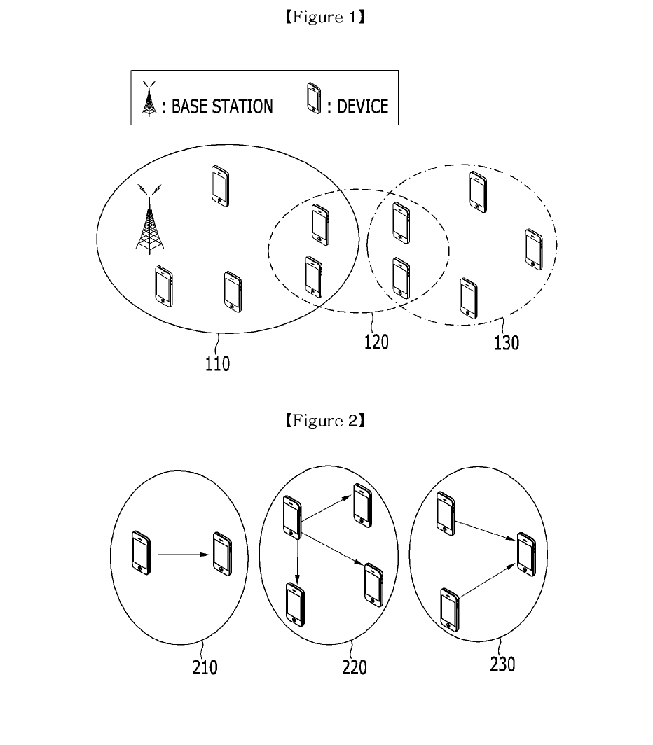

FIG. 1 is a diagram illustrating various environments in which device-to-device discovery according to an exemplary embodiment of the present invention may be generated.

First, as represented by reference numeral 110 in FIG. 1, the device-to-device discovery may be generated when all the devices are within network coverage. Further, as represented by reference numeral 130 in FIG. 1, the device-to-device discovery may be generated in the case in which all the devices are outside the network coverage. Finally, as represented by reference numeral 120 in FIG. 1, the device-to-device discovery may be generated in the case in which some of the devices are within the network coverage and the rest of the devices are outside the network coverage (i.e., in the case of partial network coverage).

FIG. 2 is a diagram illustrating a connection relationship of the device-to-device discovery according to the exemplary embodiment of the present invention.

A connection relationship of the device-to-device discovery may be changed depending on a relationship between a device transmitting a discovery signal and a device receiving the discovery signal. In FIG. 2, reference numeral 210 represents one-to-one discovery, reference numeral 220 represents one-to-many discovery, and reference numeral 230 represents many-to-one discovery.

The one-to-one discovery 210 represents the case in which there is one device transmitting the discovery signal and one device receiving the discovery signal. The one-to-many discovery 220 represents the case in which there is one device transmitting the discovery signal multiple devices receiving the discovery signal. Further, the many-to-one discovery 230 represents the case in which there are multiple devices transmitting the discovery signal and one device receiving the discovery signal. For convenience of explanation, the one-to-one discovery 210 will be mainly described below, but the present invention is not limited thereto. In the case of the one-to-many discovery 220, each device receiving the discovery signal may perform the same operation as the device receiving the discovery signal in the one-to-one discovery 210. Further, in the case of the many-to-one discovery 220, each device transmitting the discovery signal may perform the same operation as the device transmitting the discovery signal in the one-to-one discovery 210.

The device-to-device discovery may be classified into two schemes based on a subject to determine the discovery signal. The first discovery method corresponds to the case in which the subject to determine the discovery signal is a base station and the second discovery method corresponds to the case in which the subject to determine the discovery signal is a device.

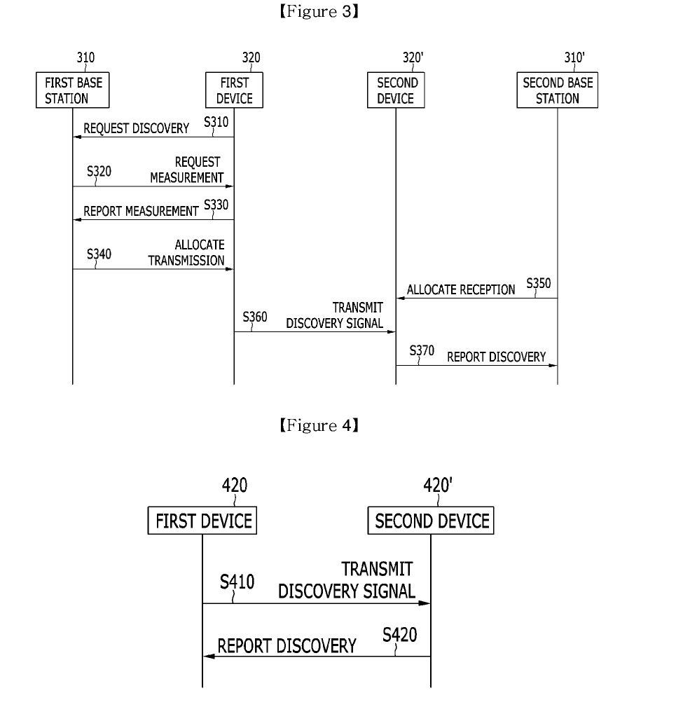

FIG. 3 is a diagram illustrating a procedure of a first discovery method according to an exemplary embodiment of the present invention.

In FIG. 3, a first device 320 is a device transmitting the discovery signal, and a second device 320′ is a device receiving the discovery signal. The first device 320 may belong to a first base station 310 and the second device 320′ may belong to a second base station 310′, but the first device 320 and the second device 320′ may belong to the same base station.

In FIG. 3, it is assumed that the subject to determine the discovery signal is the base station, but the subject to determine the discovery signal may not be the base station according to the environment in which the discovery is applied. In the case in which all the devices are outside the network coverage (network coverage of a base station), one of the devices may be set as a coordinator. In this case, the coordinator may serve as the base station in FIG. 3. When some of the devices are within the network coverage and the rest of the devices are outside the network coverage (i.e., the case of reference numeral 120 of FIG. 1), one of the devices presented within the network coverage may be selected as a relay node. In this case, the relay node may serve as the base station in FIG. 3. In other words, in the first discovery method, the subject to determine the discovery signal may be the base station, and may be a different device from the device transmitting or receiving the discovery signal.

As illustrated in FIG. 3, the first discovery method may include requesting discovery (S310), requesting measurement (S320), reporting the measurement (S330), allocating transmission (S340), allocating reception (S350), transmitting a discovery signal (S360), and reporting the discovery (S370). Each step in FIG. 3 may not be sequentially generated and some of the steps may be omitted depending on the circumstances. As one example, in FIG. 3, the first device 320 transmits the discovery request, but unlike as shown FIG. 3, the first base station 310 may transmit the reception allocation to the first device 320.

The first device 320 may transmit the discovery request to the first base station 310 (S310). In FIG. 3, it is assumed that the first device 320 transmitting the discovery request transmits the discovery signal. However, the device transmitting the discovery request may be different from the device transmitting the discovery signal. For example, unlike as shown FIG. 3, the second device 320′ may transmit the discovery request to the second base station 310′ and the first device 320 may transmit the discovery signal. Meanwhile, when the base station instructs the discovery, the discovery request transmitted by the device may be omitted.

The discovery request may include information on an identifier for the device to be discovered. Further, the discovery request may include information on open discovery or restricted discovery.

The base station 310 may transmit the measurement request to the first device 320 (S320). To determine a physical resource to which the discovery signal is transmitted and a transmission format of the discovery signal, the first base station 310 transmits the measurement request to the first device 320. The measurement request may include information on the physical resource to be measured.

The first device 320 receiving the measurement request measures the corresponding physical resource according to the measurement request to be able to transmit the measurement report to the first base station 310 (S330). The measurement report may include the information on the physical resource suitable (preferred) to transmit the discovery signal. Further, the measurement report may include information on transmission power suitable (or preferred) to transmit the discovery signal.

The first base station 310 may transmit transmission allocation to the first device 320 (S340). The first device 320 transmits the discovery signal depending on the transmission allocation. The transmission allocation information may include an identifier for the transmission allocation or the reception allocation, an identifier for periodic transmission or aperiodic transmission, an identifier for activation or deactivation in the case of the periodic transmission, a transmission frequency, a scrambling code, a physical resource, a transmission format in the case of the aperiodic transmission, and the like.

Meanwhile, the transmission allocation may be transmitted through a physical downlink control channel (PDCCH) or a physical downlink data channel (PDDCH). When the transmission allocation is transmitted through the physical downlink control channel (PDDCH), the device may transmit reception success information to the base station. Only when successfully demodulating the physical downlink control channel (PDCCH) does the device transmit the reception success information to the base station.

In the case of the periodic transmission, the identifier for the activation or the deactivation may not be included in the transmission allocation. In this case, the identifier may be transmitted through a medium access control layer downlink control element.

The second base station 310′ may transmit the reception allocation to the second device 320′ (S350). The reception allocation (S350) may be omitted. When the second device 320′ receives the reception allocation, the second device 320′ receives the discovery signal. Meanwhile, when the second device 320′ does not receive the reception allocation, the second device 320′ performs blind demodulation on the discovery resource region to receive the discovery signal. Here, the second base station 310′ may inform the second device 320′ of the discovery resource region based on system information. As one example, the system information may be system information (SI), a system information block (SIB), or the like in the 3GPP LTE.

The reception allocation information may include the identifier for the transmission allocation or the reception allocation, the identifier for the periodic transmission or the aperiodic transmission, the identifier for activation or deactivation in the case of the periodic transmission, the transmission frequency, the scrambling code, the physical resource, the transmission format in the case of the aperiodic transmission, and the like.

Meanwhile, the reception allocation may be transmitted through the physical downlink control channel (PDCCH) or the physical downlink data channel (PDDCH). When the transmission allocation is transmitted through the physical downlink control channel (PDDCH), the device may transmit the reception success information to the base station. Only when successfully demodulating the physical downlink control channel (PDCCH) does the device transmit the reception success information to the base station.

In the case of the periodic transmission, the identifier for the activation or the deactivation may not be included in the reception allocation. In this case, the identifier may be transmitted through the medium access control layer downlink control element.

The second device 320′ receiving the discovery signal may transmit the discovery report (S370). Alternatively, the second device 320′ may not transmit the discovery report. When transmitting the discovery report, the second device 320′ may transmit the discovery report to the second base station 310′ or the first device 320. The discovery report may include the discovery identifier, received power of the discovery signal, a transmission delay of the discovery signal, and the like.

FIG. 4 is a diagram illustrating a procedure of a second discovery method according to an exemplary embodiment of the present invention.

In FIG. 4, a first device 420 transmits the discovery signal and a second device 420′ receives the discovery signal. In the second discovery method, the device transmitting the discovery signal determines the physical resource, the transmission format, the transmission power, and the like of the discovery signal. In the second discovery method, the discovery signal may be selected from the discovery resource region and may be transmitted. The first device 420 and the second device 420′ themselves may include the information on the discovery resource region. Further, the base station may inform the first device 420 and the second device 420′ of the discovery resource region in advance. The first device 420 selects one discovery resource region from the discovery resource regions to transmit the discovery signal (S410). The second device 420′ performs the blind demodulation on the discovery resource region to receive the discovery signal. The detailed description of the discovery resource region will be given below in more detail.

As a method for allowing the first device 420 to select one discovery resource region from the discovery resource regions, the following method may be used. The first method is a method for arbitrarily selecting the discovery resource region. The second method is a method using a hash function. An input of the hash function may be an identifier for a device, an identifier for a cell, or a combination of the identifier for the device and the identifier for the cell. As one example, the identifier for the device may be a cell-radio network temporary identifier (C-RNTI), an international mobile subscriber identity (IMSI), an SAE temporary mobile subscriber identity (S-TMSI), or the like in the 3GPP LTE. When the device is in an RRC_CONNECTED state, the C-RNTI, the IMSI, the S-TMSI, or the like may be used, and when the device is in an RRC_IDLE state, the IMSI, the M-TMSI, or the like may be used. Meanwhile, the identifier for the cell may be a physical cell ID, a virtual cell ID, or the like in the 3GPP LTE. The third method is a method for selecting the discovery resource region based on a physical measurement.

The second device 420′ may receive the discovery signal and then transmit the discovery report (S420). Alternatively, the second device 420′ may not transmit the discovery report. When transmitting the discovery report, the second device 420′ may transmit the discovery report to the base station to which the first device 420 or the second device 420′ belongs. The discovery report may include the discovery identifier, the received power of the discovery signal, the transmission delay of the discovery signal, and the like.

Hereinafter, the discovery resource region according to the exemplary embodiment of the present invention will be described. In the following description, a set of resources in which the discovery signal may be transmitted is defined as a discovery resource region (DRR). The discovery resource region is configured of a time domain and a frequency domain.

First, the discovery resource region of the time domain may be represented by one or multiple variable sets. Variables configuring each variable set may include an offset, a first period, a second period, a bitmap, and the like.

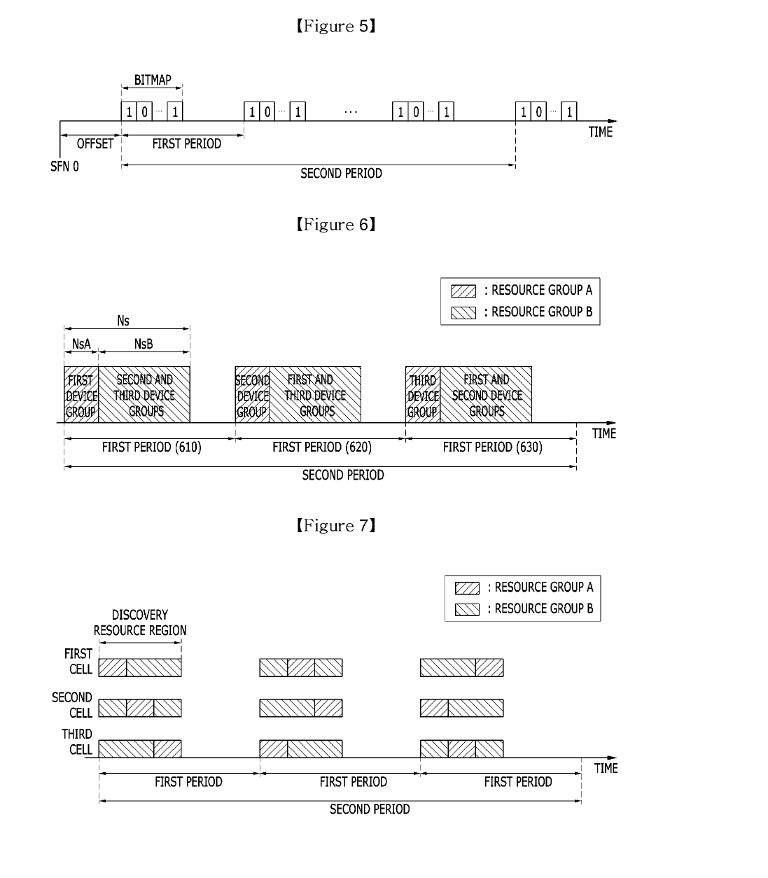

FIG. 5 is a diagram illustrating the discovery resource region in a time domain according to an exemplary embodiment of the present invention. As illustrated in FIG. 5, the discovery resource region of the time domain is represented by one variable set.

First, the offset indicates a position at which the bitmap starts based on value 0 of a system frame number (SFN). The offset value may have a value from 0 to the first period or from 0 to the second period. A unit represented by the offset value may be a subframe or a frame. Meanwhile, in the 3GPP LTE as an example of the subframe, the unit may be a resource unit representing a time interval of 1 ms, and in the 3GPP LTE as an example of the frame, the unit may be a resource unit representing a time interval of 10 ms.

A length of the bitmap may have a value from 1 to the first period. Each bit of the bitmap means a subframe. It may be identified whether the corresponding subframe is in the discovery resource region of the time domain, based on 0 or 1 which is the value of the bitmap. When the discovery resource region of the time domain is configured of discontinuous subframes, the bitmap scheme is useful. Meanwhile, when the discovery resource region of the time domain is configured of continuous subframes, it is sufficient to know only the length of the continuous subframes. Therefore, as the variables configuring each variable set, the bitmap is not used, but the length representing the number of continuous subframes may be used.

As illustrated in FIG. 5, the same bitmap based on the first period as a unit is repeatedly represented for the second period. In other words, the same bitmap is repeated as many times as a value obtained by dividing the second period by the first period for the second period. Further, the bitmap for the following second period may be the same as or different from the bitmap for the previous second period. A unit of the value of the first period may be the subframe or the frame, and a unit of the value of the second period may be the frame.

Meanwhile, when the variable set representing the discovery resource region of the time domain is plural, each variable set may further include ‘inclusion or not’ which is a variable representing inclusion or exclusion. According to the exemplary embodiment of the present invention, when the discovery resource region of the time domain is represented by two variable sets, it may be assumed that the inclusion or not of a first variable set is ‘inclusion’ and the inclusion or not of the second variable set is ‘exclusion’. In this case, the discovery resource region of the time domain includes a region represented by the first variable set and excludes a region represented by the second variable set. When the variable set representing the discovery resource region of the time domain is plural, each variable set may not include the ‘inclusion or not’ described above. In this case, the discovery resource region of the time domain may be configured of a union of the regions represented by each variable set.

The discovery resource region of the frequency domain may be represented by the bitmap of a unit of a physical resource block pair throughout a system bandwidth. Meanwhile, the discovery resource region of the frequency domain may be represented by one or a plurality of resource allocation types, in which as the resource allocation type, there may be uplink resource allocation type 0 or uplink resource allocation type 1 in the 3GPP LTE. When the discovery resource region of the frequency domain is represented by the plurality of resource allocation types, each resource allocation type may be the same as or different from each other. When different allocation types are used, an identifier for the resource allocation type identifying the resource allocation type may be included. Further, when the discovery resource region of the frequency domain is represented by the plurality of resource allocation types, the ‘inclusion or not’, which is a variable representing inclusion or exclusion, may be further included. Herein, the ‘inclusion or not’ performs the same role as the ‘inclusion or not’ which is the variable included in the discovery resource region of the time domain described above. Meanwhile, when the resource region of the frequency domain is represented by the plurality of resource allocation types, the ‘inclusion or not’ may not be included. In this case, the discovery resource region of the frequency domain may be configured of a union of the regions represented by each resource allocation type.

The discovery resource region of the frequency domain is for one subframe, but the same discovery resource region of the frequency domain may be used for the second period. The discovery resource region of the frequency domain for the following second period may be the same as or different from the discovery resource region of the frequency domain for the previous second period.

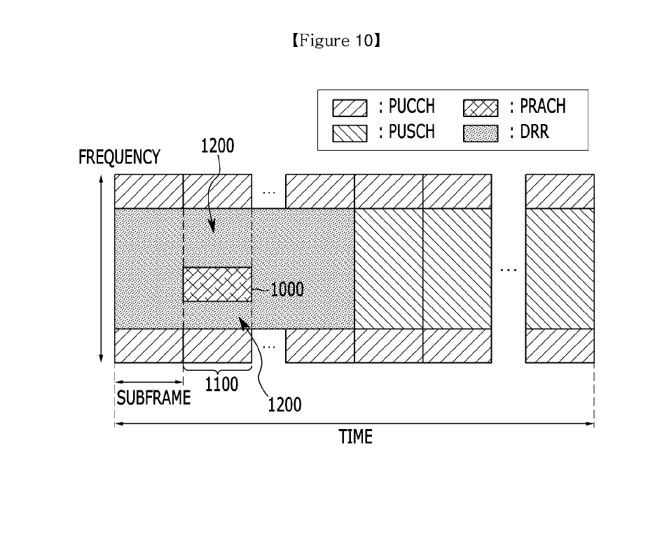

When the discovery resource region informed to the device by the base station and a physical random access channel (PRACH) resource region overlap each other, the overlapped region may be excluded from the discovery resource region. Here, the physical random access channel (PRACH) resource region may be called the physical random access channel (PRACH) resource region for a serving cell, and may be called a union of the physical random access channel (PRACH) resource regions of the serving cell and the adjacent cells. To this end, the base station may inform the device of the physical random access channel (PRACH) resource regions of the adjacent cells. A relationship between the discovery resource region and the physical random access channel (PRACH) resource region will be described in more detail with reference to FIG. 10.

The base station may inform the device of the discovery resource region, and there may be one or more discovery resource regions. According to an exemplary embodiment of the present invention, the base station may inform the device of the discovery resource region of the serving cell and the discovery resource regions of the adjacent cells. Here, the discovery resource region of the serving cell and the discovery resource regions of the adjacent cells may be the same as or different from each other. Further, the discovery resource regions of the adjacent cells may be the same as or different from each other for each adjacent cell. According to another exemplary embodiment of the present invention, the base station may inform the device of the discovery resource region of the open discovery and the discovery resource region of the restricted discovery. Here, the discovery resource region of the open discovery and the discovery resource region of the restricted discovery may be the same as or different from each other. Further, the open discovery or the restricted discovery may use one or a plurality of discovery resource regions. According to another exemplary embodiment of the present invention, the base station may inform the device of the discovery resource region used for a discovery request and the discovery resource region used for a discovery response. Here, the discovery resource region used for the discovery request and the discovery resource region used for the discovery response may be the same as or different from each other. Further, according to another exemplary embodiment of the present invention, the base station may inform the device of a discovery resource region of a radio resource control_IDLE (RRC_IDLE) device and a discovery resource region of a radio resource control_CONNECTED (RRC_CONNECTED) device. Here, the discovery resource region of the RRC_IDLE device and the discovery resource region of the RRC_CONNECTED device may be the same as or different from each other. The discovery resource in which the RRC_CONNECTED device transmits the discovery signal may be allocated to each device. As a method for allocating a discovery resource to each device, there are a semi-persistent allocation method and a dynamic allocation method. The discovery resource used by the RRC_CONNECTED device may be semi-persistently allocated. That is, the device may transmit the discovery signal to the discovery resource multiple times. Further, the discovery resource used by the RRC_CONNECTED device may be dynamically allocated. That is, the device transmits the discovery signal once in the discovery resource, and whenever the device transmits the discovery signal, the device is allocated with the discovery resource every time. Further, the discovery resource in which the RRC_CONNECTED device transmits the discovery signal may not be allocated to each device. That is, the RRC_CONNECTED device itself may select the resource transmitting its own discovery signal from the discovery resource regions. The discovery resource in which the RRC_IDLE device transmits the discovery signal may not be allocated to each device. That is, the RRC_IDLE device itself may select the resource transmitting its own discovery signal from the discovery resource regions.

As the type allowing the base station to inform the device of the discovery resource region, there may be system information, radio resource control (RRC) signaling, or a combination of the system information and the RRC signaling. The system information is a type of allowing the base station to broadcast the discovery resource regions to all the devices within the cell. The RRC signaling is a type of allowing the base station to individually transmit the discovery resource regions to each device within the cell. When the combination of the system information and the RRC signaling is used, the base station informs the device of the discovery resource region common to all the devices within the cell using the system information, and the base station informs the device of the discovery resource region which is not common to all the devices within the cell using the RRC signaling.

Meanwhile, the discovery resource region may be changed over time. When the base station informs the device of the discovery resource region using the system information, the base station may inform the device of whether the discovery resource region is changed. According to an exemplary embodiment of the present invention, in the 3GPP LTE, the base station may inform the device of whether the discovery resource region is changed using systemInfoValueTag of system information block 1 (SIB1) or systemInfoModification of a paging message.

A plurality of discovery resources are present in the discovery resource region. As described above, the device transmitting the discovery signal may select one discovery resource from the discovery resource region, and the base station may directly inform the device of the selected discovery resource. Here, the base station informs the device of a discovery resource index and thus directly informs of the discovery resource. When the base station informs the device of one discovery resource region, the base station informs the device of the discovery resource index. Meanwhile, when the base station informs the device of the plurality of discovery resource regions, the base station informs the device of the index of the discovery resource region and the discovery resource index within the discovery resource region.

As the method for allowing the base station to inform the device of the discovery resource, the radio resource control (RRC) signaling may be used. The base station may inform the device of one discovery resource using the RRC signaling. As another method, the base station informs the device of the plurality of discovery resources using the RRC signaling, and the device may select one discovery resource from the plurality of discovery resources. In this method, the device receiving the discovery signal performs the blind demodulation on all the plurality of resources informed by the base station using the RRC signaling to discover the discovery signal.

By another method for allowing the base station to inform the device of the discovery resource, the base station informs the device of the plurality of discovery resources using the RRC signaling. Here, the base station informs the device of one of the plurality of discovery resources using a MAC control element (MAC CE), a physical downlink control channel (PDCCH), or an enhanced physical downlink control channel (EPDCCH).

When the base station informs the device of the discovery resource, the base station may include transmitting/receiving identifiers. In this case, the device may use the transmitting/receiving identifiers to determine whether to transmit or receive the discovery signal using the corresponding discovery resource.

The device transmitting the discovery signal transmits the discovery signal using the known discovery resource by the above method, and the device receiving the discovery signal demodulates the discovery signal using the known discovery resource by the above method. The method for informing the device transmitting the discovery signal of the discovery resource and the method for informing the device receiving the discovery signal of the discovery resource may be the same as or different from each other. Meanwhile, the base station may inform the device transmitting the discovery signal of the discovery resource and may not inform the device receiving the discovery signal of the discovery resource. In this case, the device receiving the discovery signal performs the blind demodulation on all the discovery resources within one or a plurality of discovery resource regions.

The base station informs the device of the discovery resource region, and the device may select one discovery resource from the discovery resource regions to transmit the discovery signal. When the base station informs the device of the plurality of discovery resource regions, an operation of the device transmitting the discovery signal and an operation of the device receiving the discovery signal may be different from each other. When the base station informs the device of the discovery resource region of the serving cell and the discovery resource regions of the adjacent cells, the device transmitting the discovery signal selects one discovery resource from the discovery resource regions of the serving cell to transmit the discovery signal. Meanwhile, the device receiving the discovery signal performs the blind demodulation on the discovery resource region of the serving cell and the discovery resource regions of the adjacent cells. Further, when the base station informs the device of the discovery resource region of the RRC_IDLE device and the discovery resource regions of the RRC_CONNECTED device, the device transmitting the discovery signal selects one discovery resource from the corresponding discovery resource regions according to its own state (i.e., RRC_IDLE or RRC_CONNECTED) to transmit the discovery signal. Meanwhile, the device receiving the discovery signal performs the blind demodulation on the discovery resource region of the RRC_IDLE and the discovery resource region of the RRC_CONNECTED.

The device may arbitrarily select one discovery resource from the discovery resource regions to transmit the discovery signal. The device may perform the arbitrary selection, targeting all the discovery resource regions, and may also perform the arbitrary selection, excluding a specific subframe from the discovery resource region. Meanwhile, the device may perform the arbitrary selection, targeting resource group A or resource group B, and may perform the arbitrary selection, excluding a specific subframe from the resource group A or the resource group B. To smoothly operate a cellular link, the specific subframe may be excluded from the discovery resource region. Otherwise, the operation of transmitting or receiving the discovery signal may hinder an operation of the cellular link. The resource group A or the resource group B will be described below in more detail. Here, the specific subframe may be configured of all or some of a subframe configured to allow the device transmitting the discovery signal to transmit the physical random access channel (PRACH), a subframe cell-specifically or UE-specifically configured to transmit a scheduling request (SR), a subframe cell-specifically or UE-specifically configured to transmit a sounding reference signal, a subframe transmitting the physical layer uplink control channel including uplink Ack/Nack (A/N), a subframe transmitting the physical layer uplink control channel including periodic channel state information (CSI), a subframe transmitting the physical layer uplink data channel, and the like. Here, the uplink A/N may, in more detail, be the uplink A/N for the physical layer downlink data channel corresponding to initial transmission of downlink semi-persistent scheduling (SPS). Further, the subframe transmitting the physical layer uplink data channel may, in more detail, be the subframe transmitting the physical layer uplink data channel corresponding to initial transmission or retransmission of the uplink SPS.

The discovery resource region may be divided into two groups which do not overlap each other. One of the two groups is the resource group A and the other thereof is the resource group B. The resource group A may occupy the discovery resource that is relatively smaller than that of the resource group B.

The devices of each cell may be divided into Ng device groups. The base station may explicitly inform the device of the Ng which indicates the number of groups. Further, the base station may implicitly inform the device of the Ng at the second period and the first period which are a variable indicating the resource region of the time domain. According to an exemplary embodiment of the present invention, the Ng may be a value obtained by dividing the second period by the first period. When the base station explicitly or implicitly informs the device of the Ng, the Ng may be transmitted to the device, included in the system information.

The device may select the device group based on the arbitrary selection. Further, the device may select the device group based on the hash function. The input of the hash function may be the identifier for the device, the identifier for the cell, or the combination of the identifier for the device and the identifier for the cell. As one example, the identifier for the device may be the cell-radio network temporary identifier (C-RNTI), the international mobile subscriber identity (IMSI), the SAE temporary mobile subscriber identity (S-TMSI), or the like in the 3GPP LTE. When the device is in the RRC_CONNECTED state, the C-RNTI, the IMSI, the S-TMSI, or the like may be used, and when the device is in the RRC_IDLE state, the IMSI, the M-TMSI, or the like may be used. Meanwhile, the identifier for the cell may be the physical cell ID, the virtual cell ID, or the like in the 3GPP LTE.

In one first period, devices belonging to one device group transmit the discovery signals using the resource group A and devices belonging to the rest of the groups transmit the discovery signals using the resource group B. In the next first period, the devices belonging to different groups of devices transmit the discovery signals using the resource group A.

FIG. 6 is a diagram illustrating the method for allocating a discovery resource region according to the exemplary embodiment of the present invention to a plurality of groups. In FIG. 6, it is assumed that the Ng is 3, that the resource group A occupies NsA subframes, and that the resource group B occupies NsB (=Ns−NsA) subframes. Ns means a total number of subframes in the discovery resource region (DRR) of one period.

In a 1^{st} first period 610, devices belonging to a first device group transmit the discovery signals using the resource group A and devices belonging to the rest of the groups (second and third device groups) transmit the discovery signals using the resource group B.

In a 2^{nd} first period 620, devices belonging to a second device group transmit the discovery signals using the resource group A and devices belonging to the rest of the groups (first and third device groups) transmit the discovery signals using the resource group B.

Further, in a 3^{rd} first period 630, devices belonging to a third device group transmit the discovery signals using the resource group A and devices belonging to the rest of the groups (first and second device groups) transmit the discovery signals using the resource group B.

In FIG. 6, it is assumed that Ng=3 and that the resource group A and the resource group B are each explicitly present, but one of the resource group A and the resource group B in the discovery resource region may be explicitly present or the other thereof may be implicitly present. In this case, only the devices of the device group belonging to the resource group which is explicitly present transmit the discovery signals, and the devices of the device group belonging to the resource group which is implicitly present do not transmit the discovery signals. According to an exemplary embodiment of the present invention, the resource group A may be explicitly present and the resource group B may be implicitly present. In this case, in the 1^{st} first period, only the devices belonging to the first device group transmit the discovery signals, and in the 2^{nd} first period, only the devices belonging to the second device group transmit the discovery signals. Further, in the 3^{rd} first period, only the devices belonging to the third device group transmit the discovery signals. In addition, according to another exemplary embodiment of the present invention, the resource group B may be explicitly present and the resource group A may be implicitly present. In this case, in the 1^{st} first period, only the devices belonging to the rest of the groups other than the devices belonging to the first device group transmit the discovery signals, and in the 2^{nd} first period, only the devices belonging to the rest of the groups other than the devices belonging to the second device group transmit the discovery signals. Further, in the 3^{rd} first period, only the devices belonging to the rest of the groups other than the devices belonging to the third device group transmit the discovery signals. Meanwhile, FIG. 6 illustrates the second period, but the second period may be omitted. In this case, in a specific first period, the device group transmitting the discovery signal using the resource group A may be determined as follows. According to an exemplary embodiment of the present invention, the device group transmitting the discovery signal may be determined using the resource group A depending on a value obtained by performing a modulo operation on an index of the first period using the Ng.

The resource group A and the resource group B may be determined as follows. The discovery resource region may be divided into a plurality of resource groups which do not overlap each other. Each resource group may be identified from the others in the time domain, and in this case, each resource group may be configured of continuous subframes and may also be configured of discontinuous subframes. Meanwhile, each resource group may be identified from the others in the frequency domain, and in this case, each resource group may be configured of continuous physical resource block pairs (PRB-pairs) and discontinuous physical resource block pairs. Further, each resource group may be identified from the others in a combination of the time domain and the frequency domain.

A first method for determining the resource group A and the resource group B divides the discovery resource region into Ng resource groups, in which the resource group A is configured of one of the Ng resource groups and the resource group B is configured of Ng−1 resource groups. A second method for determining the resource group A and the resource group B divides the discovery resource region into two resource groups, in which the resource group A is configured of NsA subframes, NprbA physical resource block pairs, or the NsA subframes and NsprA physical resource block pairs, and the resource group B is configured of resources remaining by excluding the resource group A from the discovery resources.

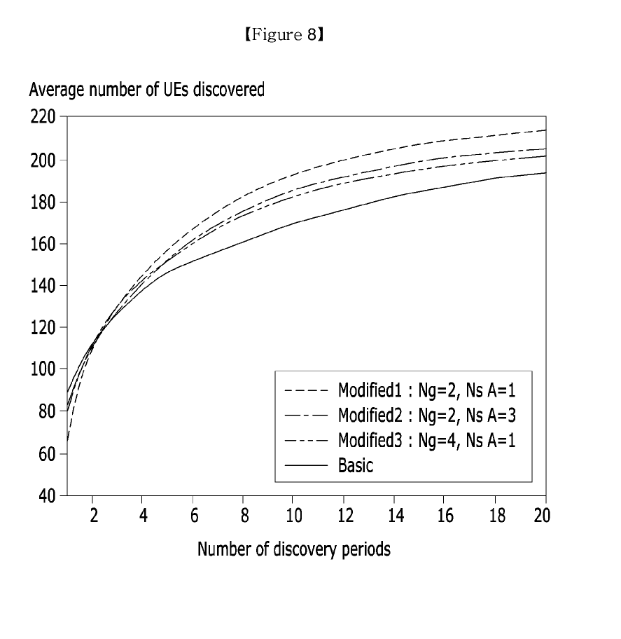

A maximum of Ng resource group A—resource group B patterns may be present depending on a form of the resource group configuring the resource group A and the resource group B. In one cell, the resource group A—resource group B patterns may be the same, and different Ng resource group A—resource group B patterns may also be used depending on the index of the first period. Further, among different cells, each cell may also use the same resource group A—resource group B patterns, and each cell may also use different resource group A—resource group B patterns depending on the physical cell identifier or the virtual cell identifier. FIG. 7 is a diagram illustrating the resource group A—resource group B according to an exemplary embodiment of the present invention, in which three resource groups are identified in the time domain. Further, in FIG. 7, it is assumed that different resource group A—resource group B patterns are used for each cell, and each cell also uses different resource group A—resource group B patterns FIG. 8 is a diagram illustrating a comparing simulation between a basic scheme and the scheme according to the exemplary embodiment of the present invention. The basic scheme is a random selection scheme (represented by Basic in FIG. 8) which does not consider the device and the resource group, and the scheme according to the exemplary embodiment of the present invention is a random selection scheme (represented by Modified1, Modified2, and Modified3 in FIG. 8) which considers the device and the resource group like in FIG. 6.

In FIG. 8, it is assumed that Ns=16, and the rest of the conditions are shown in the following Table 1. As illustrated in FIG. 8, it may be appreciated that the scheme according to the exemplary embodiment of the present invention has more average number of UEs discovered than the basic scheme. Further, it may be appreciated that as the NsA (resource allocated to the resource group A) becomes smaller and the Ng which is the number of resource groups (Modified1 in FIG. 8) becomes smaller, more devices are discovered. Further, discovery services of various devices requesting different performance may be supported by controlling the Ng and the NsA.

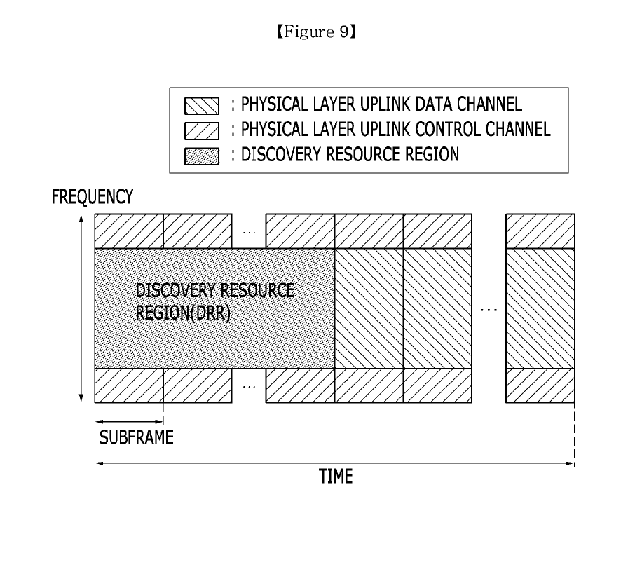

TABLE 1

| Parameter | Assumption |
|---|---|
| Layout | Hexagonal grid, 3sectors per macro site, 19 |
| | macro sites with wrap around Option1: Urban |
| | macro (500 m ISD) + 1RRH/Indoor Hotzone |
| | per cell |
| Carrier frequency | 2 GHz |
| System bandwidth | 10 MHz |
| Network synchronization | All eNBs are synchronized |
| Channel model | According to TR 36.843 v1.0.0 |
| UE drop | According to TR 36.843 v1.0.0 |
| UE RX parameters | Max transmit power of 23 dBm, 1 Tx, 2 Rx |
| | antenna, Antenna gain 0 dBi, Noise FIG. 9 dB |
| In-band emission | According to TR 36.843 v1.0.0 with W, X, Y, |
| | Z = [3, 6, 3, 3] dB |
| Discovery bandwidth | 44 PRBs |
| Number of discovery | 16 subframes |
| subbframes per period | |
| Discovery signal format | PUSCH of 1 PRB-pair, QPSK |
| Message size | 104 bit |
| UE mobility | 3 km/hr |

The discovery resource region may be located at a portion of the resource to which the uplink channel is transmitted. FIG. 9 is a diagram illustrating multiplexing of the discovery resource region and the physical layer uplink channel according to the exemplary embodiment of the present invention.

As illustrated in FIG. 9, the base station may multiplex the discovery resource region and the subframe to which the physical layer uplink data channel is transmitted, in the time domain. Further, the base station may multiplex the discovery resource region and the physical resource block pair to which the physical layer uplink control channel is transmitted, in the frequency domain. In FIG. 9, the physical layer uplink control channel may be a physical uplink control channel and the physical layer uplink data channel may be a physical uplink shared channel. FIG. 9 illustrates an example of the discovery resource region, in which the discovery resource region occupies the temporally continuous subframe and the discovery resource region may occupy the temporally discontinuous subframe.

When the device transmits the physical layer uplink channel or the physical layer uplink signal, for the cellular link to be smoothly operated, the transmission/reception of the discovery signal may be restricted. In the subframe in which the device transmits the physical layer uplink data channel or the physical layer uplink control channel, the device does not transmit or receive the discovery signal but transmits the physical layer uplink data channel or the physical layer uplink control channel. Further, the devices do not transmit or receive the discovery signal in the subframe in which the devices are cell-specifically configured to transmit the sounding reference signal. In other words, the device determines whether the subframe for the discovery signal collides with the subframe for the physical layer uplink channel or the physical layer uplink signal, and if so, does not transmit or receive the discovery signal in the corresponding subframe but transmits the physical layer uplink channel or the physical layer uplink signal. Here, the subframe for the physical layer uplink channel or the physical layer uplink signal may be a subframe transmitting the above-mentioned physical layer uplink data channel (PUSCH), a subframe transmitting the physical layer uplink control channel (PUCCH), or a subframe cell-specifically configured to transmit the sounding reference signal, and may be a subframe in which a resource region 1000 configured by a physical random access channel to be described below is included.

The physical random access channel (PRACH) may occupy a portion of the resource region to which the physical layer uplink data is transmitted. Therefore, as illustrated in FIG. 10, the resource region 1000 for the physical random access channel may overlap the resource transmitting or receiving the discovery signal. The device transmitting the physical random access channel in a subframe 1100 in which the resource region 1000 configured by the physical random access channel is included does not transmit or receive the discovery signal in the subframe 1100 in which the resource region 1000 configured by the physical random access channel is included. On the other hand, the device which does not transmit the physical random access channel in the subframe 1100 in which the resource region 1000 configured by the physical random access channel is included does not transmit or receive the discovery signal in the resource region 1000 configured by the physical random access channel. In other words, the device does not transmit or receive the discovery signal independent of whether the device transmits or does not transmit the physical random access channel in the resource region 1000 configured by the physical random access channel. By doing so, the device may transmit the physical random access channel without being hindered by the transmission/reception of the discovery signal. Further, the base station may receive the physical random access channel without being hindered by the discovery signal.

Meanwhile, the device which does not transmit the physical random access channel in the subframe 1100 in which the resource region 1000 configured by the physical random access channel is included may transmit or receive the discovery signal in the rest of a resource 1200 other than the resource region 1000 configured by the physical random access channel and the resource region to which the physical layer uplink control channel is transmitted in the subframe 1100. For the device to transmit the sounding reference signal in the subframe 1100 in which the device may transmit or receive the discovery signal, the cell-specifically configured subframe may be excluded. Further, the subframe in which the device transmits the physical layer uplink data channel, the physical layer uplink control channel, or the physical random access channel may be excluded from the subframe 1100 in which the device may transmit or receive the discovery signal.

Meanwhile, the device may support the simultaneous transmission of the discovery signal and the physical layer uplink

In this case, the device may transmit the discovery signal and the physical layer uplink to the same subframe, respectively. The device may inform the base station of whether the simultaneous transmission of the discovery signal and the physical layer uplink is supported using the RRC signaling. Further, the base station may inform the device of whether the simultaneous transmission of the discovery signal and the physical layer uplink is permitted using the RRC signaling. Here, the physical layer uplink may be the physical layer uplink channel, the physical layer uplink signal, or a combination of the physical layer uplink channel and the physical layer uplink signal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention may be used in the wireless communication system.

1. A method for transmitting a discovery signal by a device, comprising:
determining whether a first period for a physical layer uplink channel or signal and a second period for the discovery signal are overlapping; and
if the first period and the second period are overlapping and the physical layer uplink channel or signal is transmitted in the overlapping period, not transmitting the discovery channel signal in the overlapping period.

2. The method of claim 1, further comprising
receiving a resource configuration for transmitting the discovery signal from a base station.

3. The method of claim 2, wherein
the resource configuration include an offset information, a bitmap information, and a repetition information of the bitmap.

4. The method of claim 3, wherein
the offset information indicates a position at which the bitmap starts.

5. The method of claim 2, wherein
the resource configuration is received from the base station through radio resource control signaling.

6. The method of claim 1, wherein
the first period for the physical layer uplink data channel or signal is a subframe transmitting a physical layer uplink control channel.

7. The method of claim 1, wherein
the first period is a subframe cell-specifically configured to transmit a sounding reference signal.

8. The method of claim 1, wherein
the first is a subframe in which a resource region of a physical random access channel is included.

9. The method of claim 8, wherein
the device is a device transmitting the physical random access channel.

10. A method for transmitting or receiving a discovery signal by a device, comprising:
determining whether a physical random access channel is transmitted in a subframe in which a resource region of the physical random access channel is included; and
if it is determined that the physical random access channel is not transmitted in the subframe, transmitting or receiving the discovery signal in the rest of the resource excluding the resource region of the physical random access channel and the physical layer uplink control channel from the subframe.

11. The method of claim 10, wherein
the subframe is a subframe being excluded from a subframe cell-specifically configured to transmit a sounding reference signal, a subframe transmitting a physical layer uplink data channel, or a subframe transmitting the physical layer uplink control channel.

12. A method for transmitting a discovery signal by a device, the method comprising:
receiving discovery resource information indicating discovery resource for transmitting the discovery signal from a base station; and
transmitting the discovery signal by using the discovery resource information,
wherein the discovery resource information includes discovery period information indicating discovery period for transmitting the discovery signal, subframe bitmap indicating subframes used for transmitting the discovery signal, and offset information indicating start subframe of the discovery period.

13. The method of claim 12, wherein
the discovery resource information further includes repetition information indicating repetition times of the subframe bitmap during the discovery period.

14. The method of claim 12, wherein
the discovery resource information is received by RRC (Radio Resource Control) signaling.

15. The method of claim 12, further comprising:
receiving random access information indicating random access resource from the base station,
wherein, if the random access resource is overlapping with the discovery resource indicated by the discovery resource information, the overlapped resource is excluded from the discovery resource for transmitting the discovery signal.

16. The method of claim 15, wherein,
if the device transmits uplink signal through the random access resource, the device doesn't transmit the discovery signal.

17. A method for transmitting a discovery signal to a counterpart device by a plurality of devices, comprising:
dividing the plurality of devices into a group including a first device group and a second device group;
dividing a resource region used to transmit the discovery signal into a group including a first resource group and a second resource group;
transmitting, by the first device group, the discovery signal using the first resource group, in a first period;
transmitting, by the second device group, the discovery signal using the second resource group, in the first period;
transmitting, by the second device group, the discovery signal using the first resource group, in a second period; and
transmitting, by the first device group, the discovery signal using the second resource group, in the second period.

18. The method of claim 17, wherein
the first resource group has a smaller amount of resources than the second resource group.

19. The method of claim 17, wherein
the dividing of the plurality of devices includes dividing the plurality of devices into a group including the first device group, the second device group, and a third device group, and
the method further comprises: transmitting, by the third device group, the discovery signal using the second resource group, in the first period and the second period;
transmitting, by the third device group, the discovery signal using the first resource group, in a third period; and
transmitting, by the first device group and the second device group, the discovery signal using the second resource group, in the third period.

20. The method of claim 19, wherein
the dividing of the plurality of devices includes:
informing, by a base station, the plurality of devices of the number of groups; and
selecting, by each of the plurality of devices, their own groups using a hash function.
